(19) United States
(12) Patent Application Publication
(10) Pub. No.: US 2008/0155066 A1
(43) Pub. Date: Jun. 26, 2008

(54) Method For Configuring an Automation Component of an Automation System, and Corresponding Automation System

(75) Inventors: Mirko Danz, Feucht (DE); Johannes Extra, Erlangen (DE); Peter Wagner, Hersbruck (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, Munchen (DE)

(21) Appl. No.: 10/597,958

(22) PCT Filed: Jan. 28, 2005
(86) PCT No.: PCT/EP2005/050366

§ 371 Date: Aug. 14, 2006

(30) Foreign Application Priority Data
Feb. 13, 2004 (DE) 10 2004 007 231.0

(51) Int. Cl. G06F 15/177

(52) U.S. Cl. 709/220

(57) ABSTRACT

The aim of the invention is to improve the configuration of an automation system. To this end, a number of configuration data records are provided in a server connected to a client of an automation system via means of communication, whereby the client and server depict respective automation components. The client to be configured requests one of the number of configuration data records (S1, S5). Afterwards, the server transmits the requested configuration data record (S2, S6). Finally, the transmitted configuration data record is stored and activated in the client. This enables an automatic configuration of a client in an automation system.

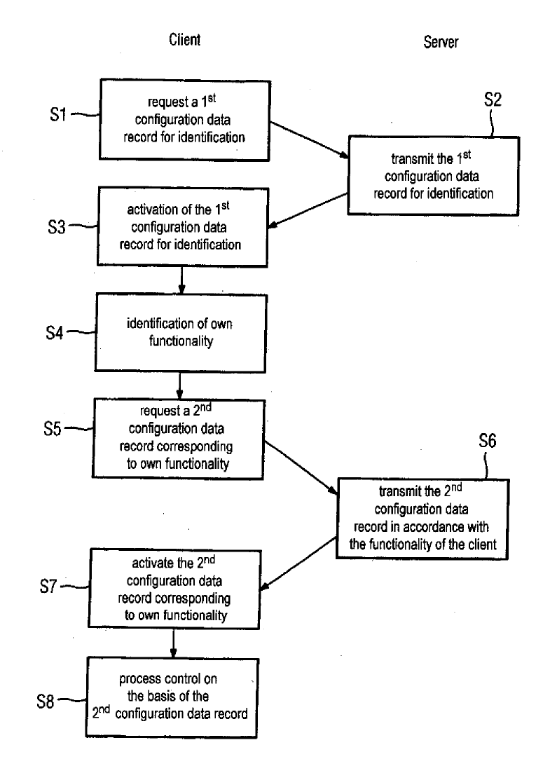

The present invention relates to a method for automatic configuration of an automation component. The present invention also relates to a corresponding automation system having a client and a server which is connected to the client via communication means. The term “client” in the present document means a configuration client which receives a configuration from a configuration server. Furthermore, the term “server” should be understood as meaning the configuration server which has been mentioned and which provides appropriate configurations.

Complex manufacturing appliances are typically controlled with the aid of automation appliances. The manufacturing appliances are frequently of modular design, and each module has an associated automation appliance. The automation appliances are interconnected with the aid of a communication network to form an automation system. One automation appliance within the communication network is used as a server, and the others are normally each used as a client with respect to the configuration.

It may be necessary to set up a machine or a manufacturing appliance again, to convert it for a different purpose, or to rectify a defect in the manufacturing appliance. In any case, one of the modules normally has to be replaced for this purpose, or a new module has to be added to the manufacturing appliance. When the new module is connected, its associated automation appliance must be configured in accordance with the functionality of the module.

As is known, the configuration process is carried out by direct intervention by the operator in the system. In this process, this operator loads an appropriate configuration from an engineering system onto the new module to be added. This configuration is then normally stored in a memory card, which may be a plug-in memory card. Alternatively, the configuration process can be carried out by insertion of a memory card, on which a specific configuration has already been stored, into the respective client.

This type of configuration is on the one hand relatively complex, and on the other hand is subject to errors.

The object of the present invention is thus to provide a method by means of which an automation system and/or its components can be configured more easily and more reliably. A further aim is to provide a corresponding automation system.

According to the invention, this object is achieved with the aid of a method for automatic configuration of an automation component of an automation system by provision of a server which is connected to the client via communication means and in which a plurality of configuration data records are stored, with the server and the client each representing automation components, request for one of the plurality of configuration data records by the client, transmission of the requested configuration data record by the server, and storage of the transmitted configuration data record in the client.

Furthermore, the invention provides an automation system which has a plurality of automation components, having a client and a server which is connected to the client via communication means, with the client and server each representing automation components, and in which case a plurality of configuration data records can be stored in the server, the client can request one of the plurality of configuration data records, the server can transmit a requested configuration data record to the client, and a transmitted configuration data record can be stored in the client.

It is thus advantageously possible for an automation appliance without a configuration loaded in it to be automatically supplied with a configuration appropriate for its specific function within a machine, when that machine is connected.

If required, the request by the client for the configuration data record comprises a selection from the plurality of configuration data records as a function of the functionality of the client. This means that a plurality of configuration data records are available on the server, and the client actively selects a matching configuration data record as appropriate for its functionality.

A plurality of configuration data records can optionally be stored in the server for selection by a type of client as appropriate for the functionality of this client. This allows a plurality of versions of one configuration data record to be used, which have been created for example on the basis of further developments.

Before the request for a configuration data record, it may be necessary for the client to be automatically identified within a defined machine context. This means that it is no longer necessary for the operator to identify the client to be connected, thus removing one error source and speeding up the configuration process.

At least two of the plurality of configuration data records can advantageously be stored locally in the client. Thus, for example, when the client is plugged in in a different plug-in slot in the communication network, there is no need for the client to once again request a configuration data record via the communication network, thus loading the network. The client should then be designed such that it automatically activates the appropriate one of the at least two configuration data records for its operation. This further simplifies and automates the starting up of a new client within the automation system.

In addition to the configuration data records, firmware data records can also be stored on the server such that they can be called up. The client can then request one of the firmware data records when required, and can store the requested firmware data record in an internal memory medium, and can activate it. In this case, the firmware data records may also be different for different clients, and may also be available at the same time in different versions. This process of writing firmware to the client should in this case be regarded in the widest sense as well, as an additional way to configure the client. The automatic writing of the correct firmware thus allows even a complex configuration to be implemented automatically.

With regard to communication, the client will have been or is preferably matched to the automation system, such that it is possible to start up the client during continuous operation of the automation system. For this purpose, by way of example, the client is configured such that it processes process steps to be carried out within the cycle time predetermined by the communication system, so that it does not interfere with the ongoing communication in the automation system.

The client and the central server optionally run on a single automation appliance. This allows the topology of the automation system to be simplified in certain cases.

The configuration data records for different machine upgrade levels for one machine are advantageously loaded in the server by an engineering system. The configuration data records are then distributed further automatically by the appropriate requests from the clients. Alternatively, the configuration data records for the various machine upgrade levels may have already been loaded in advance in the server or central machine component. As a further alternative, it is possible for machines to be prefabricated with a plurality of machine configurations, in which case the user can select and activate a desired machine configuration by appropriate aids, for example a MMI (man-machine interface). The latter variant makes it possible to configure the automation system semi-automatically.

It may also be advantageous for a configuration data record in the client to be automatically loaded in the server. This is the situation when the configuration data record stored in the client is more up-to-date than that in the server. This loading into the server is particularly helpful when one client is intended to be used more than once in one specific plug-in slot, which differs from that corresponding to the configuration data record stored in the server.

The method according to the invention can particularly preferably be used for automatic configuration of a client in order to start it up in an automation system. In this case, for start-up purposes, the client requests a communication address, for example an IP address, and activates this address. After this, the client is able to communicate in the communication network. The actual configuration of the client can then be carried out on the basis of the principles described above. For this purpose, it is first of all necessary - as already indicated - for the client to request a first configuration data record, by means of which its own functionality can be identified. This configuration data record for identification purposes is then activated automatically. After identifying itself, the client can now be configured as appropriate for its identified functionality, by means of a second configuration data record. Finally, this second configuration data record is activated, and the client can carry out a process on the basis of its functionality, at the installation location of the machine. This allows a start-up process to be carried out automatically in a plurality of steps.

For starting up an automation appliance, it may also be advantageous for the configuration data records for different machine upgrade levels for a machine to be stored in advance in a memory medium or in the server by an engineering system. This is because this allows the configuration data records to be requested and activated at a later start-up time for the machine, by means of operator input on the machine, so that no engineering system is required at the start-up time.

The present invention will now be explained in more detail with reference to the attached drawing, which shows a flowchart of a method according to the invention.

The exemplary embodiment described in more detail in the following text represents one preferred embodiment of the present invention.

A client is coupled to an existing automation system for the first time. For this purpose, the method steps described in conjunction with the attached figure are carried out automatically. First of all, the client checks whether it has a configuration which allows its functionality to be identified. This functionality includes the location or a plug-in slot of the client on the machine, the type of automation appliance, the specific functionality of the automation appliance, etc. If the client does not have a configuration or a configuration data record for identification of its functionality, it requests that an initial configuration such as this be loaded from the central server using the system service, in accordance with step S1 in the figure. The initial configuration can be defined by the user himself.

In a step S2, the server sends the initial configuration or the first configuration data record for identification purposes to the requesting client. As soon as the client has received this first configuration data record, the client will activate this record in accordance with step S3. This allows the functionality in the client's user program to be identified (see step S4). The operator or user can in this case make use of his own methods for identification of the functionality.

After identification of its own functionality, the client uses this identification to request the configuration associated with it, that is to say a second configuration data record, from the server, in accordance with step S5. In step S6, the server then loads the second configuration data record, which has been requested by the client, into an appropriately provided memory medium in the client. Matching firmware versions, a required technological packet, a matching project (terminology from automation engineering) can also be loaded from the server to the client for this purpose.

During this process, the client is always the active part, and is the component requesting the required configuration from the server. The intelligence for selection of the configuration is also located in the client. The server represents only a file server for different configurations. This means that, in the end, the client itself requests the configurations and/or configuration data records which are stored in it.

The client may already locally have a further configuration data record (not illustrated in the figure). The second and the further configuration data record are thus available to the client for selection. In this case, the client decides which of the two data records is the more up-to-date. In the present example, the second configuration data record is more up-to-date, for which reason the client activates this data record in step S7. The client then carries out its process on the basis of the second configuration data record, in accordance with step S8.

However, if the client locally identifies one or more configuration data records which are more up-to-date than the configuration data record stored in the server, it may transmit this or these to the server (not illustrated in the figure). The server transfers the more up-to-date configuration data record or records to its database and can then supply this to the appropriate client in response to renewed requests. However, in this context, the intelligence in the server is restricted to keeping new configurations including the identification in the file system. One example of a situation in which the configuration in the client is more up-to-date is when a configuration has been loaded directly in the client by means of an engineering system.

The server and the client may be located in one appliance. This means that a client may also at the same time be used as a server, provided that it has an appropriate memory medium in which a plurality of configuration data records can be stored.

A DHCP/nameserver allows a configuration data record to be loaded in a plurality of steps into a “neutral component” which does not yet have a communication address. In this case, the client procedure is as follows:
request an IP (Internet Protocol) address from a DHCP/nameserver (dynamic host configuration protocol); during this process, the client is assigned a dynamic IP address for the actions up to activation of the IP address of the configuration corresponding to the functionality;
request the configuration or the configuration data record for identification of its own functionality;
request the specific configuration as appropriate for the functionality of the client, and
start the specific configuration for an automation task.

The abovementioned steps allow automatic configuration of a “neutral automation appliance” in the machine, without an engineering system or operator input. In other words, the connected component (machine module) uses a loaded identification program to determine its own identification without any manual operator actions (for example plug-in slot coding, communication address, MAC addresses of the neighbors in the case of IRTE (industrial real-time Ethernet), its own user procedures, etc.) It requests the matching configuration for its own identification from the associated configuration server, as the active part. Finally, the connected component activates the loaded configuration automatically without any operator action on the MMI or in the engineering system.

In summary, the following advantages can be determined for the user:
a server can be provided with all of the necessary configuration data records by plugging in a memory card. A client to be connected is then automatically supplied with the configuration appropriate for its functionality.
all of the configurations of a machine are loaded by the engineering system only in the server for the machine, and the configurations are then automatically made available to the requested clients.
configurations are loaded in the client, controlled by that client, automatically, using a multiple step method.
replacement appliances are started up on the machine; that is to say no manual action is required by the operator, and no engineering system is required to start up the machine.

1.-14. (canceled)

15. A method for automatic configuration of an automation component of an automation system, comprising the steps of:
providing a server having stored therein a plurality of configuration data records;
connecting a server to a client via communication means to thereby define an automation component, request by the client to the server for receiving one of the configuration data records;
transmitting the requested configuration data record by the server to the client; and
storing of the transmitted configuration data record in the client.

16. The method of claim 15, wherein the requested configuration data record of the plurality of configuration data records is selected in dependence on the functionality of the client.

17. The method of claim 15, wherein the server stores a plurality of configuration data records in correspondence with a functionality of the client.

18. The method of claim 15, further comprising the step of autonomous identification of the client within a defined machine context.

19. The method of claim 15, wherein at least two of the plurality of configuration data records are stored locally in the client.

20. The method of claim 19, further comprising the step of operating the client by activating one of the at least two stored configuration data records in the client.

21. The method of claim 15, further comprising the steps of storing pollable firmware data records in the server, request by the client to the server for receiving one of the firmware data records, and storing and activating the received firmware data record in the client.

22. The method of claim 15, wherein the client communication is matched to the automation system to enable operation of the client during continuous operation of the automation system.

23. The method of claim 15, wherein the client and the server operate on a single automation device.

24. The method of claim 15, further comprising the step of loading the configuration data records for different machine upgrade levels for a machine in the server by an engineering system.

25. The method of claim 15, further comprising the step of automatically loading an existing configuration data record in the client in the server.

26. A method for starting up an automation component in an automation system, comprising the steps of:
requesting a communication address for initiating and activating this communication address;
configuring a client, which represents an automation component, by using a first configuration data record which enables identification of a functionality of the client, and subsequent automatic activation of the first configuration data record; and
configuring the client by using a second configuration data record in correspondence with the identified functionality, and by activating the second configuration data record.

27. The method as claimed in claim 26, further comprising the steps of storing the configuration data records for different machine upgrade levels for a machine in the server beforehand by an engineering system to allow request and activation of the configuration data records when the machine ed is later started up by an input of an operator on the machine.

28. An automation system, comprising:
a plurality of automation components, having a client defining a first automation component; and
a server defining a second automation component and connected to the client via communication means;
a plurality of configuration data records for storage in the server,
wherein the client is configured to automatically request from the server one of the configuration data records,
wherein the server in response to the request transmits a requested configuration data record to the client, and
wherein the transmitted configuration data record is stored in the client.
